(19) United States
(12) Patent Application Publication
(10) Pub. No.: US 2013/0112137 A1
(43) Pub. Date: May 9, 2013

(54) CURTAIN COATER

(71) Applicant: Andritz Kusters GmbH, Krefeld (DE)

(72) Inventors: Eduard Davydenko, Grefrath-Oedt (DE); Andreas Pesch, Krefeld (DE)

(73) Assignee: Andritz Kusters GmbH, Krefeld (DE)

(21) Appl. No.: 13/669,336

(22) Filed: Nov. 5, 2012

(30) Foreign Application Priority Data
Nov. 9, 2011 (DE) 102011118053.6

(51) Int. Cl. B05C 5/00

(52) U.S. Cl. 118/300

(57) ABSTRACT

Curtain coater for discharging liquid or pasty application medium in the form of a curtain moving substantially under the force of gravity onto a moving paper or board web, comprising a nozzle body which has a first distributor chamber extending along a discharge width, to which the application medium is supplied via at least one supply line, and in the flow direction (S), a flow channel which breaks up the application medium into sectional flows, and has a second distributor chamber, which discharges the application medium as a curtain via an outlet slot, wherein in the flow direction, the second distributor chamber has a flow path with a plurality of direction changes, which runs through throttling points and expansion chambers.

The invention relates to a curtain coater for discharging liquid or pasty application medium according to the preamble of Claim 1.

DE 10 2009 036 853 B3 discloses a generic curtain coater which ensures that the pressure and/or volume distribution of the application medium in the transverse direction of the coater is evened out. For this purpose, a first and a second distributor chamber are arranged one after the other in the flow direction and a flow slot, which is subdivided into sectional flows, extends between these.

During the coating of a paper or board web by using a curtain coater, the coating compound is intended to be applied as uniformly as possible over the entire web width. The coating thickness must be as constant as possible over the entire web surface. The basic precondition for this is a uniform distribution of the coating compound over the outlet width with regard to the volume flow and the velocity. In the case of large working widths of 8 to 10 m, for example, and low application weights of 2 to 10 g/m², for example, this object is particularly difficult to fulfil. Fluctuating operating conditions such as large variation ranges with regard to the viscosity of the coating colour and the application volumes constitute an additional requirement when achieving a uniform distribution of the application.

DE 197 55 625 A1 discloses a curtain coater in which the nozzle body is composed of two wall-like parts which have a length corresponding to the desired working width. Incorporated into a long side of one of the parts is a longitudinal groove which, after the two parts have been joined together, forms a distributor chamber. Connected to the distributor chamber is an outlet channel extending over the working width, from which the coating colour emerges. In order to be able to apply low volumes of coating colour to paper or board webs of great width uniformly over the working width without disruption under fluctuating conditions, for example fluctuating viscosity or changing application volumes, the flow conditions in the distributor chamber are influenced by the volume flows supplied. To this end, at least two supply channels are connected to the distributor chamber, each having a device for adjusting the volume flow of coating colour supplied. Hose-clamping valves or diaphragm valves are preferably used for the volume flow adjustment. The volume flows of each supply channel are therefore adjusted separately. A second distributor chamber is arranged between the distributor chamber and the outlet channel for the purpose of further evening. Between the then first distributor chamber and the second distributor chamber there is an additional flow channel. The requirement for additional actuating elements for the transverse profile adjustment is disadvantageous. Also disadvantageous is the fact that the individual partial streams from the individual sections cannot be combined to form a uniform film flow in the outlet slot. In the outlet slot and in the curtain, streaks then arise, which lead to coating defects and which cause production disruptions.

It is therefore an object of the invention to devise a curtain coater which ensures high uniformity of the distribution of an application medium over an outlet width.

This object is achieved by the features of Claim 1.

In this way, a curtain coater is devised which combines the sectional flows (partial flows) to form a uniform film flow in the curtain and avoids the formation of streaks. Thus, evening out the pressure and/or volume distribution of the application medium in the transverse direction of the curtain coater can be combined with a uniform film flow.

Labyrinthine flow path patterns are particularly preferred.

Further refinements of the invention can be gathered from the following description and the claims.

The invention will be explained in more detail below by using the exemplary embodiments illustrated in the appended figures, in which:

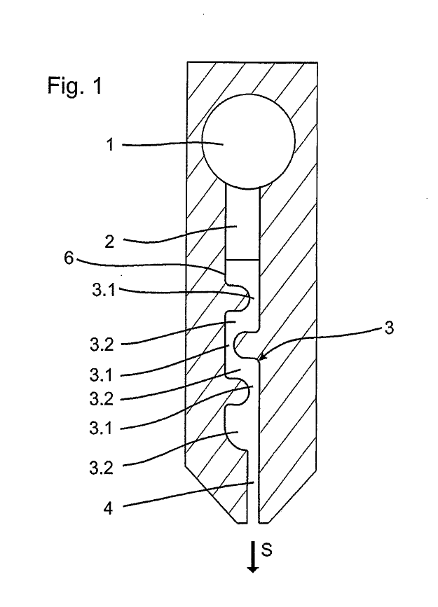

FIG. 1 shows, schematically, a cross-sectional view of the nozzle body of a curtain coater,

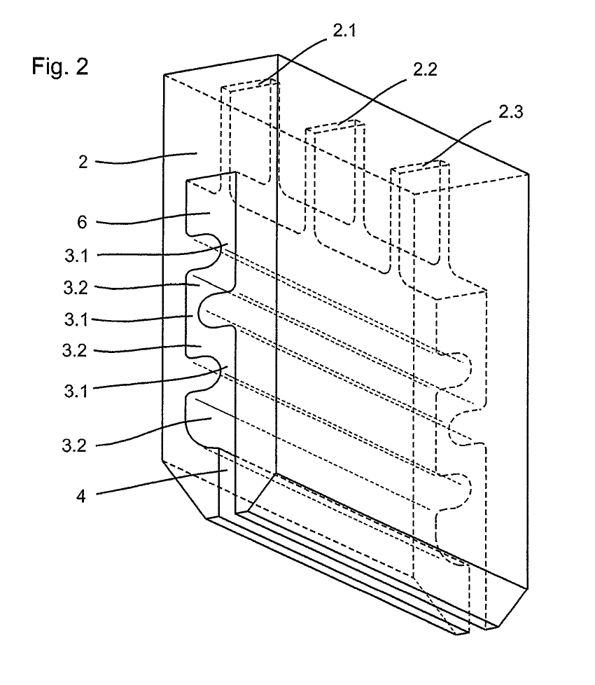

FIG. 2 shows, schematically, a perspective view of a second distributor chamber according to a first exemplary embodiment,

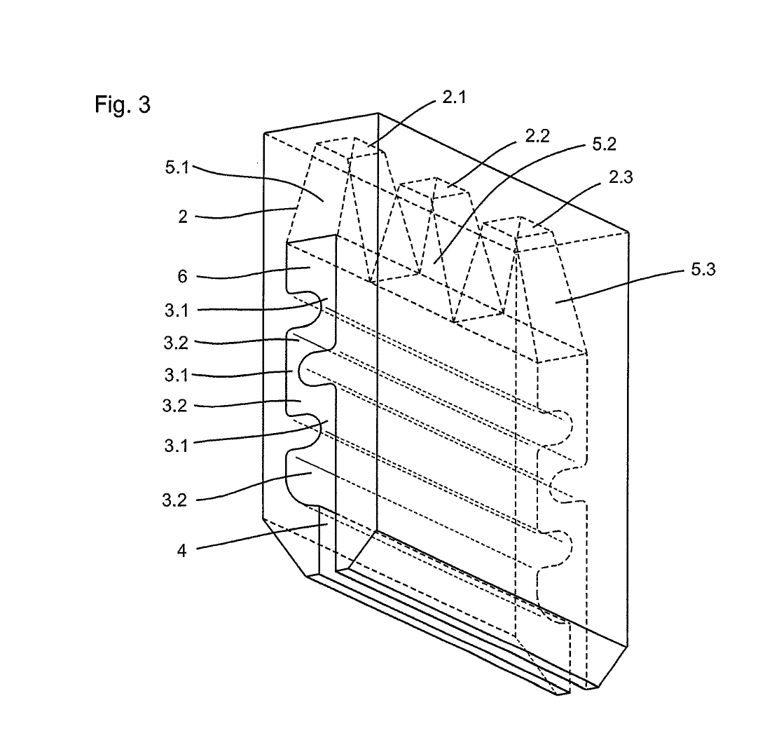

FIG. 3 shows, schematically, a perspective view of a second distributor chamber according to a second exemplary embodiment,

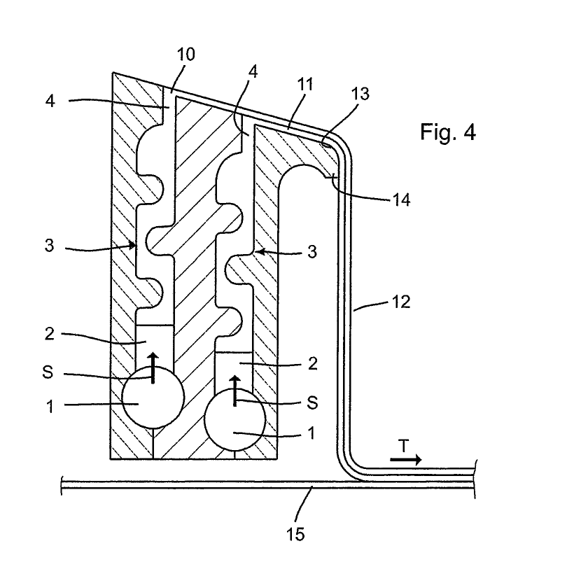

FIG. 4 shows, schematically, a cross-sectional view of a cascade nozzle for multilayer web coating.

The invention relates to a curtain coater for discharging liquid or pasty application medium in the form of a curtain moving substantially under the force of gravity onto a moving paper or board web.

As FIG. 1 shows, the curtain coater comprises a nozzle body which has a first distributor chamber 1 extending along a discharge width. This distributor chamber 1 is supplied with the application medium via at least one supply line (not shown). The flow direction S of the application medium to be supplied can originate from one end of the distributor chamber 1. The nozzle body further comprises a second distributor chamber 3, which discharges the application medium as a curtain via an outlet slot 4. Between the first 1 and second distributor chamber 3, an additional flow channel 2 is provided, which breaks up the application medium into sectional flows 2.1, 2.2, 2.3. The flow direction S here is perpendicular to the transverse direction of the curtain coater.

In the flow direction S, the second distributor chamber 3 has a flow path having a plurality of direction changes, which runs through throttling points 3.1 and expansion chambers 3.2. As FIG. 1 shows, the flow channel 2 is preferably followed by a first throttling point 3.1. This first throttling point 3.1 is formed by a flow loop, for example, which reduces the flow path. The throttling point 3.1 is thus a local flow path narrowing. This reduction in the flow path is carried out eccentrically in relation to a flow centreline of the flow channel 2. The first throttling point 3.1 is preferably followed in the flow direction S by a first expansion chamber 3.2, in which the cross section of the flow path is larger as compared with the throttling point 3.1. The flow cross section is preferably substantially equal to the flow cross section of the flow channel 2 or larger than the latter. The first expansion chamber 3.2 is preferably followed by a second throttling point 3.1, which is again arranged eccentrically but with a lateral offset in relation to the flow centreline of the flow channel 2. The second throttling point 3.1 is preferably followed by a second expansion chamber 3.2, which is followed by a third throttling point 3.1 with a lateral offset with respect to the second throttling point 3.1. Before the outlet slot 4, a further expansion chamber 3.2 is preferably also provided, the dimensions of which can be larger than the expansion chambers 3.2 arranged upstream. On account of the eccentric arrangement of the throttling points 3.1, the flow path has a plurality of direction changes, which ensure linking of the edges of sectional flows 2.1, 2.2, 2.3, the expansion chambers 3.2 ensuring adequate intermediate calming of the flow. The result is the formation of a uniform film flow in the distributor chamber 3, starting from the sectional flows 2.1, 2.2, 2.3. Here, the arrangement of the throttling points 3.1 can determine a flow path pattern.

In the flow direction, a throttling point 3.1 and an expansion chamber 3.2 are preferably arranged alternately. The throttling points 3.1 and the expansion chambers 3.2 are moreover preferably each formed to be as wide as the machine. The direction change in the flow path can, for example, be regular.

The second distributor chamber 3 is preferably of labyrinthine form.

The throttling points 3.1 can form a sequence of flow loops, in each case an expansion chamber 3.2 being arranged between two flow loops.

At least three throttling points 3.1 and two expansion chambers 3.2 are preferably arranged one after another in the flow direction S.

As FIG. 2 shows, the flow channel 2 is broken down into a multiplicity of individual guide channels for the sectional flows 2.1, 2.2, 2.3. As the exemplary embodiment of FIG. 3 shows, the guide channels for the sectional flows 2.1, 2.2, 2.3 can each merge on the outlet side into a diffuser 5.1, 5.2, 5.3 for the sectional flows 2.1, 2.2, 2.3 to be led together on the outlet side.

The sectional flows 2.1, 2.2, 2.3 preferably extend from the first distributor chamber 1 at right angles to the transverse direction of the coater. Furthermore, the sectional flows 2.1, 2.2, 2.3 are preferably arranged in a row.

Between the ends of the sectional flows 2.1, 2.2, 2.3 on the outlet side and the second distributor chamber 3, a remaining partial height of a flow channel 6 can also be formed as a machine-width flow slot, in order to lead the individual sectional flows 2.1, 2.2, 2.3 together again before the entry into the second distributor chamber 3 takes place.

The parts of the curtain coater touched by the flow are stressed mechanically and chemically. It is therefore advantageous to produce these from non-rusting steels, for example from the following materials such as molybdenum-free Cr—Ni steels, molybdenum-containing Cr—Ni steels or ferritic-austenitic duplex steels.

Alternatively, the nozzle body can consist of a thermoplastic. In order to meet high requirements on the dimensional stability, chemical resistance, behaviour with respect to moisture (moisture absorption less than 1.5%), dimensional stability (low swelling under 0.1%), the high-performance plastics (amorphous and partially crystalline), such as PEI, PEEK, PPSU, PTFE, PVDF, POM to DIN EN ISO 1043-1, are suitable as a material for producing the nozzle body, in particular the base 2.4.

The nozzle body described in accordance with the invention can be used for curtain coating in accordance with the slide-die method or a slot-die method.

FIG. 4 shows a curtain coater for the multilayer application of liquid or pasty medium to a moving paper or board web. The nozzle body forms separate media flows 10, 11 for the layers to be applied, which are led together to form a curtain 12 at the exit from the outlet slots 4 of a cascade nozzle body. To this end, a plurality of the nozzle bodies described above are arranged beside one another, two here by way of example. Over a supply lip 13 having a drip edge 14, the curtain 12 emerging from the outlet slots 4 flows onto the moving web 15, which moves under the coating apparatus in the transport direction T.

In a departure from the exemplary embodiments of FIG. 1 to FIG. 3, in the exemplary embodiment according to FIG. 4 the flow direction S is directed upwards. According to FIG. 1 to FIG. 3, the flow direction S is directed downwards. Otherwise, the above explanations apply in a corresponding way here.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

1. Curtain coater for discharging liquid or pasty application medium in the form of a curtain moving substantially under the force of gravity onto a moving paper or board web, comprising a nozzle body which has a first distributor chamber extending along a discharge width, to which the application medium is supplied via at least one supply line, and in the flow direction, a flow channel which breaks up the application medium into sectional flows, and has a second distributor chamber, which discharges the application medium as a curtain via an outlet slot, wherein, in the flow direction, the second distributor chamber has a flow path with a plurality of direction changes, which runs through throttling points and expansion chambers.

2. Curtain coater according to claim 1, wherein the direction change is regular.

3. Curtain coater according to claim 1, wherein the second distributor chamber is of labyrinthine form.

4. Curtain coater according to claim 1, wherein the throttling points and the expansion chambers are each formed to be as wide as the machine.

5. Curtain coater according to claim 1, wherein a throttling point and an expansion chamber are arranged alternately in the flow direction.

6. Curtain coater according to claim 1, wherein the arrangement of the throttling points determines a flow path pattern.

7. Curtain coater according to claim 1, wherein the throttling points form a sequence of flow loops, in each case an expansion chamber being arranged between two flow loops.

8. Curtain coater according to claim 1, wherein at least three throttling points and two expansion chambers are arranged one after another in the flow direction.

9. Curtain coater according to claim 1, wherein the flow channel is broken down into a multiplicity of individual guide channels which each merge on the outlet side into a diffuser for the sectional flows to be led together on the outlet side.

10. Curtain coater according to claim 1, wherein the sectional flows extend from the first distributor chamber at right angles to the transverse direction of the applicator.

11. Curtain coater according to claim 1, wherein the sectional flows are arranged in a row.
